(19) United States
(12) Patent Application Publication
(10) Pub. No.: US 2026/0188338 A1
(43) Pub. Date: Jul. 2, 2026

(54) GUIDE ROBOT AND GUIDE ROBOT OPERATION METHOD

(71) Applicant: LG ELECTRONICS INC., Seoul (KR)

(72) Inventors: Mihyun PARK, Seoul (KR); Hyeongjin KIM, Seoul (KR); Soojin LEE, Seoul (KR)

(73) Assignee: LG ELECTRONICS INC., Seoul (KR)

(21) Appl. No.: 19/109,807

(22) PCT Filed: Sep. 8, 2022
(86) PCT No.: PCT/KR2022/013558

§ 371 Date: Mar. 7, 2025

(51) Int. Cl. G10L 21/034; G05D 1/686; G05D 105/30

(52) U.S. Cl. CPC G10L 21/034; G05D 1/686; G05D 2105/315

(57) ABSTRACT

A guide robot and a guide robot operation method are disclosed. In the guide robot, according to the present disclosure, speech volume settings of the guide robot can be adjusted by being set as more subdivided so that various changing situations can be reflected, and the loudness of the speech volume can be changed and adjusted by estimating intention of use according to whether there are visitors in the vicinity or whether visitors approach. Therefore, the visitors can more accurately recognize content spoken by the robot, and use inconveniences caused by the use of the same loud sound volume are resolved.

### TECHNICAL FIELD

The present disclosure relates to a guidance robot and a method of operating the guidance robot and, more particularly, to a guidance robot capable of traveling autonomously and delivering an utterance by adjusting the volume and a method of operating the guidance robot.

### BACKGROUND ART

In recent years, there has been ever-increasing interest in guidance robots providing various guidance services to users. While autonomously traveling without user operation, for example, guidance robots provide various guidance services to users by performing a voice conversation function or an interaction function using a touchscreen.

For example, guidance robots may operate in various modes depending on the situation, such as a signage mode targeting a multiplicity of persons and a kiosk mode targeting an individual.

Sound adjustment has typically been performed using simple techniques, regardless of the various modes of the guidance robots. Specifically, guidance robots in the related art face problems in adaptively adjusting sound in various situations. The reason for this is that the sound categories are limited to only the following: a warning utterance designated in such a manner as not to set the magnitude of sound, an utterance that can be set by a user, and background sound.

In this regard, Korean Patent Application Publication No. 10-2008-0064557 (hereinafter referred to as ‘Prior Document 1’) discloses a method of improving the articulation of a voice signal by analyzing a background noise signal in the receiver's environment. However, in Prior Document 1, the volume is adjusted in real time. This adjustment may prevent the counterpart person from recognizing the voice, and thus, is not particularly appropriate for movable robots, such as guidance robots.

In addition, when many persons are present, performing signage advertisement at a high volume of sound may increase the advertisement effect. However, when no person is present, continuously performing signage advertisement at the same volume of sound may cause inconvenience to a guard or others and increase electric power consumption.

Accordingly, even when sound is not adjusted each time in the guidance robot, it may be necessary to adaptively adjust sound to eliminate user inconvenience in various situations, such as when many persons are present, when no person is present, and when a person approaches closely.

In addition, guidance robots have typically performed signage advertisement through a single display. Even when a plurality of displays are used, guidance robots have output the same signage advertisement due to sound-related problems. Accordingly, problems arise in that advertisement utilization decreases.

### DISCLOSURE OF INVENTION

### Technical Problem

One object of one or several embodiments of the present disclosure is to provide a guidance robot capable of setting and adjusting the volume of its utterance in a subdivided manner in such a manner as to reflect various changing situations and a method of operating the guidance robot.

Another object of one or several embodiments of the present disclosure is to provide a guidance robot capable of variably adjusting the volume of an utterance by estimating the intention of a visitor in the vicinity to use the guidance robot, depending on whether or not the visitor approaches, and a method of operating the guidance robot.

A further object of one or several embodiments of the present disclosure is to provide a guidance robot capable of reflecting characteristics of a traveling space while maintaining the same hearing time and thus adaptively adjusting and outputting the volume of an utterance by considering characteristics of the movable guidance robot, and a method of operating the guidance robot.

Another object of one or several embodiments of the present disclosure is to provide a guidance robot capable of displaying different signage advertisements on displays on both of its surfaces, respectively, and uttering sound from the direction of the display with the higher signage advertisement effect, depending on the situation, and a method of operating the guidance robot.

Still another object of one or several embodiments of the present disclosure is to provide a guidance robot capable of adjusting the direction of an utterance on a per-situation basis in such a manner that a visitor can clearly recognize the guidance robot's utterance, and a method of operating the guidance robot.

### Solution to Problem

A guidance robot according to the present disclosure can change settings and deliver an utterance in such a manner that a range for adjusting the volume of the utterance varies by distinguishing between a case where the robot's utterance targets an unspecified multiplicity of persons and a case where the robot's utterance targets a specific person.

In addition, even in a case where an utterance targets an unspecified multiplicity of persons, when no visitor is present in the vicinity, the utterance can be delivered by automatically decreasing the magnitude of the volume.

In addition, when a specific person approaches while delivering an utterance that targets an unspecified multiplicity of persons, the case where the utterance targets a specific person can be recognized and thus, the range for adjusting the volume can be adaptively changed.

According to one aspect of the present disclosure, there is provided a guidance robot including: a sensing unit that collects situational information in the vicinity; a traveling-enabling unit that moves the guidance robot; a display on which visual information is displayed; an output unit that outputs an utterance associated with preset guidance information or visual information displayed on the display; and a processor that is electrically connected to the sensing unit, the display, and the output unit and adjusts the volume of the utterance to be output to the output unit based on the collected situational information.

According to one embodiment, in the guidance robot, based on the collected situational information, the processor may perform control to adjust the volume of the utterance within a first setting range when a first condition is satisfied and may perform control to adjust the volume of the utterance within a second setting range different from the first setting range when a second condition is satisfied, and the maximum value within the second setting range may be set to be lower than the maximum value within the first setting range.

According to one embodiment, in the guidance robot, the first condition may be for a case where the utterance targets an unspecified multiplicity of persons, and the second condition may be for a case where the utterance targets a specific person.

According to one embodiment, in the guidance robot, the sensing unit may include a sensor detecting the traveling speed of the guidance robot, and the processor may recognize the traveling speed detected through the sensor, as the collected situational information, and, based on the detected traveling speed, may adjust the volume of the utterance within the first setting range.

According to one embodiment, in the guidance robot, when the utterance associated with the preset guidance information is output, the processor may adjust the magnitude of the volume of the utterance either within the first setting range or in a manner that exceeds the first setting range, in such a manner as to be proportional to the magnitude of the detected traveling speed.

According to one embodiment, in the guidance robot, the sensing unit may include a sensor for detecting a traveling space for the guidance robot, and the processor may adjust the volume of the utterance within the first setting range, depending on whether or not the traveling space recognized through the sensor is a closed space or a quite space.

According to one embodiment, in the guidance robot, when the traveling space recognized through the sensor is determined to be a closed space or a quiet space, the processor may adjust the magnitude of the volume of the utterance either to the minimum value within the first setting range or to a value lower than the minimum value.

According to one embodiment, in the guidance robot, the sensing unit may include a sensor for detecting whether or not a visitor is present in the vicinity, and the processor may adjust the volume of the utterance within the first setting range based on the sensor's detection of whether or not a visitor is present in the vicinity.

According to one embodiment, in the guidance robot, in response to the sensor detecting that no visitor is present in the vicinity, the processor may adjust the magnitude of the volume of the utterance either to the minimum value within the first setting range or to a value lower than the minimum value.

According to one embodiment, in the guidance robot, the processor may recognize that one of the visitors in the vicinity approaches, and, based on verification of the approaching visitor's intention to use the guidance robot, may change the volume of the utterance to a value lower than before within first setting range or may change the volume of the utterance within the second setting range, for the purpose of adjustment.

According to one embodiment, in the guidance robot, in response to the approaching visitor moving away by a predetermined range or greater, the processor may adjust the volume of the utterance to a value higher than before within the first setting range.

According to one embodiment, in the guidance robot, the display may include: a first display provided on the front surface of the body of the guidance robot; and a second display provided on the rear surface of the body of the guidance robot, and, based on the collected situational information, the processor may control the output unit in such a manner as to output an utterance associated with content displayed on one of the first and second displays.

According to one embodiment, in the guidance robot, while the guidance robot travels, the processor may control the output unit in such a manner as to output an utterance associated with content displayed on the second display.

According to one embodiment, in the guidance robot, the sensing unit may detect the approaching direction of a visitor, and the processor may control the output unit in such a manner as to output an utterance associated with content displayed on one, corresponding to the detected approaching direction, of the first and second displays.

According to one embodiment, in the guidance robot, in response to the detected approaching direction corresponding to both the first and second displays, the processor may control the output unit in such a manner as to output an utterance associated with content displayed on any one display selected according to a preset reference.

According to one embodiment, in the guidance robot, the preset reference may be associated with priorities for controlling the first and second displays, which are assigned based on the collected situational information.

According to one embodiment, in the guidance robot, the output unit may be an array speaker capable of outputting the utterance in a plurality of different directions, and, when the guidance robot outputs the utterance, based on the situational information, the processor may control the array speaker in such a manner as to output the utterance in a selected direction.

According to another aspect of the present disclosure, there is provided a method of controlling a guidance robot, the method including: a step of displaying content on a display; a step of collecting situation information in the vicinity; a step of adjusting the volume of an utterance associated with preset guidance information or the displayed content based on the collected situational information; and a step of outputting the utterance at the changed volume.

According to one embodiment, in the method, in the step of adjusting the volume of the utterance, based on the collected situational information, the volume of the utterance within a first setting range may be adjusted when a first condition is satisfied, and the volume of the utterance may be adjusted within a second setting range different from the first setting range when a second condition is satisfied, and the maximum value within the second setting range may be set to be lower than the maximum value within the first setting range.

According to one embodiment, the method may further including: a step of displaying different content items on a first display provided on the front surface of the body of the guidance robot and a second display provided on the rear surface of the body of the guidance robot, respectively; and a step of outputting an utterance associated with content displayed on one of the first and second displays at the adjusted volume, based on the collected situational information.

### Advantageous Effects of Invention

A guidance robot and a method of operating the guidance robot according to one or several embodiments of the present disclosure can subdivide a range for adjusting the volume of an utterance by distinguishing between a case where the robot's utterance targets an unspecified multiplicity of persons and a case where the robot's utterance targets a specific person. Consequently, the utterance can be delivered at the magnitude of the volume suitable for each situation. Accordingly, a visitor can more accurately recognize the robot's uttered content, and the inconvenience in use, caused by the excessive magnitude of the same sound, can be eliminated.

In addition, a guidance robot and a method of operating the guidance robot according to one or several embodiments of the present disclosure can maintain the same hearing time regardless of a traveling speed. Consequently, the transfer of an utterance can be further enhanced. Furthermore, an improvement in usability can be expected by understanding the characteristics of a traveling space and adjusting the magnitude of an utterance.

In addition, a guidance robot and a method of operating the guidance robot according to one or several embodiments of the present disclosure can adjust an utterance in accordance with changing situations, such as when no visitor is present in the vicinity, when a specific person approaches while the utterance targets an unspecified multiplicity of persons, and when an approaching visitor moves away. Consequently, smarter guidance and advertisement can be provided.

In addition, a guidance robot and a method of operating the guidance robot according to one or several embodiments of the present disclosure can display different advertisement content items on displays, respectively, on both the surfaces, thereby increasing an advertisement effect. As a result, the display with a higher advertisement effect can be selected by considering both the traveling direction of the robot and the direction in which a visitor approaches, and thus, the associated sound can be uttered. Consequently, the advertisement effect can be further maximized.

In addition, a guidance robot and a method of operating the guidance robot according to one or several embodiments of the present disclosure can adaptively adjust the direction of an utterance on a per-situation basis using an array speaker, thereby outputting the utterance. Consequently, an alert can be provided more directly and the sense of space can be further enhanced.

### BRIEF DESCRIPTION OF DRAWINGS

FIG. 1 is a view illustrating an example of a guidance robot according to the present disclosure.

FIG. 2 is a block diagram illustrating an exemplary configuration of the guidance robot according to the present disclosure.

FIG. 3 is a flowchart illustrating the application of a range for utterance volume settings in the guidance robot according to the present disclosure in a manner that varies depending on whether or not to satisfy a condition corresponding to situational information. FIG. 4 is a view illustrating an exemplary setting screen associated with FIG. 3.

FIG. 5 is a flowchart illustrating the adjustment of the volume of an utterance in the guidance robot according to the present disclosure, depending on its traveling speed.

FIG. 6 is a flowchart illustrating the adjustment of the volume of an utterance in the guidance robot according to the present disclosure, depending on its traveling space.

FIG. 7 is a flowchart illustrating the adjustment of the volume of an utterance in the guidance robot according to the present disclosure, depending on the number of visitors and whether or not a visitor approaches.

FIGS. 8 and 9 are views illustrating that while the guidance robot according to the present disclosure, which includes a plurality of displays, travels, different content items are displayed on the plurality of displays, respectively, and that an utterance is selectively output based on the situational information.

FIGS. 10, 11, 12A, and 12B are views illustrating various examples, respectively, where in the guidance robot according to the present disclosure that includes the plurality of displays, an utterance associated with content on a display selected based on the direction in which a visitor approaches is output.

FIG. 13 is a view that is referenced to describe a method of selectively outputting an utterance in a case where a visitor approaches all of the plurality of displays included in the guidance robot according to the present disclosure.

FIGS. 14A to 14D are views illustrating various examples, respectively, where the guidance robot according to the present disclosure uses an array speaker to vary the direction of outputting an utterance.

### MODE FOR THE INVENTION

A description will now be given in detail according to one or more embodiments disclosed herein, with reference to the accompanying drawings, and regardless of reference numerals, the same or similar components are given the same reference number, and descriptions thereof will be omitted. The terms “module” and “unit” as used herein interchangeably or individually used to refer to a constituent element only for convenience in description in the present specification and therefore are not themselves intended to take on different meanings or to depict different functions. In describing the embodiments disclosed herein, moreover, a detailed description of a related well-known technology will be omitted when it is determined that it would obscure the gist of the present disclosure. Furthermore, the accompanying drawings are provided only for a better understanding of the embodiments disclosed herein, and are not intended to limit the technical ideas disclosed herein. Therefore, it should be understood that the accompanying drawings include all modifications, equivalents, and substitutions within the scope and technical ideas of the disclosure.

The terms including an ordinal number such as first, second, and the like may be used to describe various elements, but the elements should not be limited by those terms. The terms are used merely for the purpose of distinguishing one element from another.

It will be understood that when an element is referred to as being “connected with” another element, the element can be connected with the another element or intervening elements may also be present. In contrast, when an element is referred to as being “directly connected with” another element, there are no intervening elements present.

As used herein, the singular form is intended to include the plural forms as well, unless context clearly indicates otherwise.

In the present application, it should be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

A “guidance robot” disclosed in the present specification refers to a robot capable of providing welcome greetings, path guidance, product guidance, parking guidance, library guidance, and various types of information, such as product search information, airport information, and docent information, to users in public places, including airports, shopping malls, such as department stores, accommodations, such as hotels, and cultural complexes, such as art museums and libraries.

In addition, the “guidance robot” disclosed in the present disclosure is capable of performing autonomous traveling to guide users to paths, specific places, and other destinations.

In addition, while the “guidance robot” disclosed in the present disclosure travels within a predetermined space, objects moving in the predetermined space collectively include visitors, users, obstacles, and similar entities.

In addition, the “guidance robot” disclosed in the present disclosure may include various output means associated with touchscreens, sound output units, LEDs, tactile sensors, and similar components to provide information or guidance in various forms (e.g., visual, auditory, and tactile).

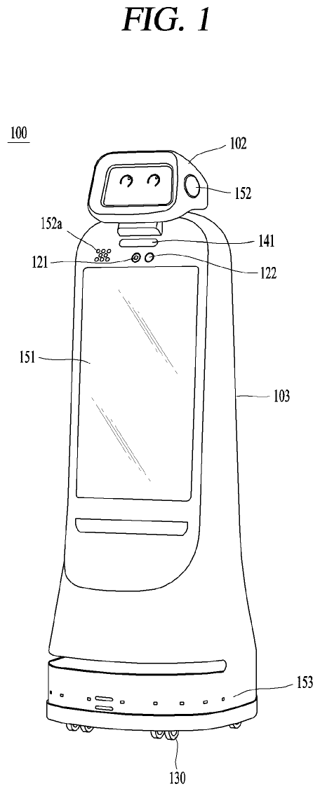

FIG. 1 is a view illustrating an example of a guidance robot 100 according to the present disclosure.

With reference to FIG. 1, the guidance robot 100 according to the present disclosure may be configured to include a head 102, a camera 121, a speaker 152, a voice recognition unit (not illustrated), a display 151, and a traveling-enabling unit 130. However, depending on the application, the guidance robot 100 according to the present disclosure may be configured to omit one or more of the constituent elements disclosed in the present specification or to further include one or more constituent elements.

The exterior appearance of the guidance robot 100 according to the present disclosure may broadly include an upper module, which includes the head 102 and the display 151, and a lower module, which includes the traveling-enabling unit 130. The upper module and the lower module may be provided in such a manner as to be detachably attached to each other.

The upper module provides a user interface that is changeable depending on service environments. The lower module provides traveling functionality for moving the main body of the guidance robot 100.

The upper module may include a body unit, which forms the main structure and includes the display 151, and a head unit 102, which includes the camera 121 or a similar component. However, depending on the application, the upper module may also be configured in such a manner that a camera is included in the body unit and that a touchscreen is arranged on the head unit 102.

The camera 121 may be provided on one side of the casing of the head unit 102 or on one side of the casing of the body unit. In addition, a plurality of cameras 121 may be provided. In this case, one camera 121 may be provided on the front surface of the main body and positioned to face forward. Another camera 121 may be provided on the lateral or rear surface and positioned to face sideways or backward. Accordingly, an angle of view covering 360 degrees can be formed.

In a case where a plurality of cameras 121 are provided, examples of a first camera may include a 3D stereo camera. The 3D stereo camera may perform functions such as obstacle detection, recognition of a user's face, and stereoscopic image capture. Using the first camera, the guidance robot 100 may detect and avoid an obstacle present in its moving direction and recognize a user, thereby performing various control operations. In addition, examples of a second camera may include a Simultaneous Localization And Mapping (SLAM) camera. The SLAM camera tracks the current location of a camera through feature mapping and performs a function of creating a 3D map based on this location. The guidance robot 100 may recognize its current location using the second camera.

In addition, the camera 121 may recognize an object within its angle of view and perform a function of capturing a still image and a moving image. In this regard, the camera 121 may include at least one of the following: a camera sensor (e.g., a CCD sensor, a CMOS sensor, or a similar type), a photo sensor (or image sensor), or a laser sensor. The camera 121 and the laser sensor may operate together to detect a touch on a 3D stereoscopic image by a detection target. The photo sensor may be stacked on a display element, and be configured to scan the motion of the detection target that approaches the touchscreen. More specifically, the photo sensor includes photodiodes and transistors (TRs) mounted in rows/columns, and thus scans an object placed on the photo sensor using an electric signal that varies with the amount of light applied to the photodiodes. That is, the photo sensor may compute the coordinates of the detection target that vary with a change in the amount of light, and acquire positional information of the detection target from these coordinates.

A sound output unit 152 performs a function of alerting the user to information to be provided, using voice and may, for example, take the form of a speaker. Specifically, a response or a search result, which corresponds to the user's voice received through a sound reception unit 122 and a voice recognition unit (not illustrated) included in the guidance robot 100, is output as voice through the sound output unit 152. The sound output unit 152 may be provided on the outer circumferential surface of the body unit, which includes the head unit 102 or the display 151. In addition, the sound output unit 152 may output voice information associated with a screen (e.g., a menu screen, an advertisement screen, or the like) displayed on the display 151.

In addition, the guidance robot 100 according to the present disclosure may include a first speaker 152a on the front surface of the body unit and a second speaker on the rear surface of the body unit. Alternatively, the guidance robot 100 may include an array speaker, capable of outputting sound in various directions, on one side of the body unit.

The sound reception unit 122 performs a function of receiving the user's voice or the like and may, for example, take the form of a microphone. The sound reception unit 122 may process an external sound signal into electrical voice data, and various noise elimination algorithms for eliminating noise that occurs in the process of inputting the external sound signal may be implemented.

The display 151 may be positioned in the lengthwise direction of the body unit that is one direction of the body unit, and display a screen to provide visual information, for example, guidance information. In addition, the display 151 may be configured to include a display module, a touch sensor, and a pressure sensor.

The display 151, for example, may be configured in such a manner as to open and close the inside of the body unit by being coupled to a movable guide mechanism. In addition, the display 151, for example, may also be configured in such a manner as to be fastened to the body unit and fixed using a fixation member.

In addition, although not illustrated in detail, the display 151 may be provided to face the opposite direction of the head 102, or the displays 151 may be provided to face the same direction as and the opposite direction of the head 102, respectively. This configuration enables the guidance robot 100 to move along a preset path in advance of the user to guide him/her to a path. Alternatively, before moving along the preset path in advance of the user, the head 102 may also first rotate by 180 degrees and thus change its exterior appearance as if the display 151 were positioned to face the opposite direction of the head 102.

In this case, the display 151 performs a function of displaying visual information (e.g., path guidance information and inquiry information) associated with a currently provided service. The user can see the display 151 installed on the rear side of the guidance robot 100 while moving along with the guidance robot 100.

In addition, the displays 151 may be provided on both the front and rear surfaces, respectively, of the main body. In this case, different screens may be displayed on a first display, provided on the front surface of the main body, and a second display, provided on the rear surface of the main body, respectively (e.g., a screen for interacting with the user is displayed on the first display, and a screen for advertisement or the like is displayed on the second display). In addition, a display unit for outputting various facial expressions of the guidance robot may be provided on the front surface of the head unit 102.

The traveling-enabling unit 130 moves and rotates the main body of the guidance robot 100. To this end, the traveling-enabling unit 130 may be configured to include a plurality of wheels and a drive motor. A driving operation by the traveling-enabling unit 130 is controlled by a processor based on a received control command. An alert may be provided through an LED output means 153 before or after the driving operation.

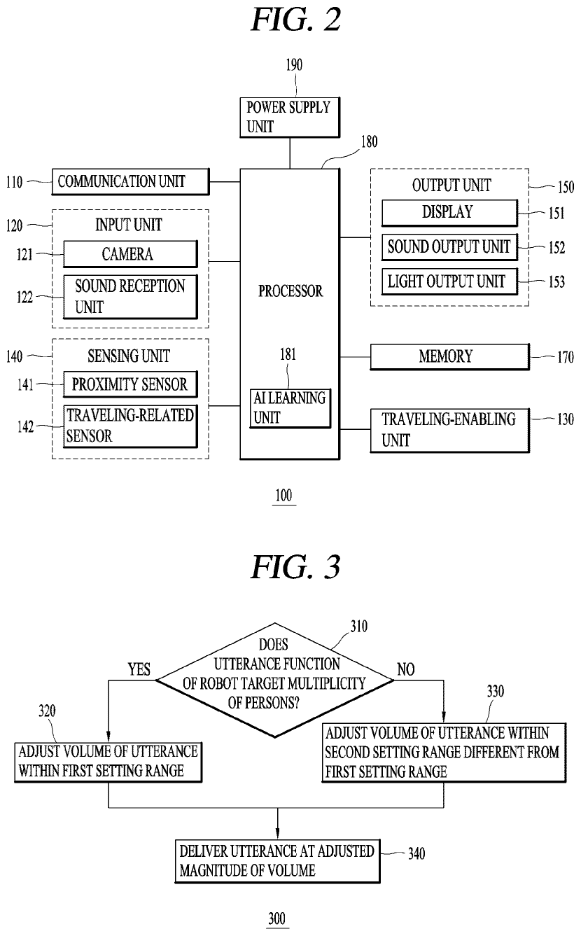

FIG. 2 is a block diagram illustrating an exemplary detailed configuration of the guidance robot according to the present disclosure.

The guidance robot 100 according to the present disclosure may include a communication unit 110, an input unit 120, the traveling-enabling unit 130, a sensing unit 140, an output unit 150, a memory 170, a processor 180, a power supply unit 190, and the like. The constituent elements illustrated in FIG. 2 are not essential for realizing the guidance robot. Therefore, the guidance robot described in the present specification may further include one or more constituent elements beyond those illustrated or may omit one or more of them.

The communication unit 110 may include one or more modules that enable wireless communication between the guidance robot 100 and an external server, for example, an artificial intelligence server, or between the guidance robot 100 and an external terminal. In addition, the communication unit 110 may include one or more modules that connect the guidance robot 100 to one or more networks.

The communication unit 110 may communicate with the artificial intelligence server or the like using wireless Internet communication technologies, for example, such as Wireless LAN (WLAN), Wireless Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), LTE-advanced (LTE-A) and others. The communication unit 110 may also communicate with an external terminal and other similar terminals by using short-range communication technologies, such as Bluetooth™, Radio Frequency Identification (RFID), Infrared Data Association (IrDA), Ultra Wideband (UWB), ZigBee, and Near Field Communication (NFC).

The input unit 120 may include a camera 121 or an image input unit for inputting an image signal, a sound reception unit 122 or a microphone for inputting an audio signal, and a user input unit (not illustrated) (e.g., a touch key, a mechanical key, or the like) for receiving information as input from a user. Signal data, voice data, and image data, which are collected by the input unit 120, may be analyzed and processed as control commands.

The traveling-enabling unit 130 moves and rotates the main body of the guidance robot 100. To this end, the traveling-enabling unit 130 may be configured to include a plurality of wheels and a drive motor. The driving operation by the traveling-enabling unit 130 is controlled by the processor 180 based on a received control command. An alert may be provided through a light output unit 153, such as LEDs, before or after the driving operation.

The sensing unit 140 may include at least one sensor for sensing at least one of the following: information within the guidance robot, information about surrounding environments near the guidance robot, or user-related information. For example, the sensing unit 140 may include at least one of the following sensors: a proximity sensor 141, an illumination sensor, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (e.g., refer to the camera 121), a microphone, a battery gauge, an environment sensor (e.g., a barometer, a hygrometer, a thermometer, a radiation detection sensor, a heat detection sensor, a gas detection sensor, or the like), or a chemical sensor (e.g., an electronic nose, a health care sensor, a biometric sensor, or the like). The guidance robot disclosed in the present specification may be utilized by combining pieces of information obtained from sensing from at least two of these sensors. In addition, the sensing unit 140 may include a traveling-related sensor 142 that detects an obstacle, a floor state, and the like.

Examples of the proximity sensor 141 may include a transmissive photoelectric sensor, a direct reflective photoelectric sensor, a mirror reflective photoelectric sensor, a high-frequency oscillation-type proximity sensor, a capacitance-type proximity sensor, a magnetic proximity sensor, an infrared proximity sensor, and other types of sensors. In addition, the proximity sensor 141 may include at least one of the following: a navigation camera, an ultrasonic sensor, a LiDAR, or a ToF sensor, and may recognize the approach and location of the detection target (e.g., the user) through this device.

In addition, the sensing unit 140 may include at least one sensor for collecting situational information. As an example, the sensing unit 140 may include one of or two or more of the following: a camera, a 3D depth camera, a LiDAR, a speed sensor, a distance sensor, an obstacle sensor, or the proximity sensor 141.

The sensing unit 140 may collect the situational information using one sensor or two or more sensors. At this point, examples of the collected situational information may include the presence or absence of a visitor within a space, the visitor's approach or departure, the visitor's direction of approach or departure, the robot's traveling speed during traveling, and features of a traveling space, and the like. In addition, examples of the situational information may include exterior features (e.g., gender, age, and similar attributes) of the approaching or departing visitor.

The situational information collected by the sensing unit 140 may be provided to the processor 180 or be stored in the memory 170.

The processor 180 may adjust the volume of an utterance, output through the sound output unit 152, in a manner that varies with the collected situational information. More specifically, the processor 180 may subdivide the targets or purposes of the robot's utterances and set utterance volume adjustment ranges, which correspond to the resulting sub-targets or sub-purposes, respectively, to be different from one another.

Based on the collected situational information, the processor 180 may select an utterance mode to adjust the volume of an utterance within a first setting range or within a second setting range different from the first setting range.

At this point, the maximum value within the first setting range may be higher than the maximum value within the second setting range. For example, for the first setting range, an utterance mode (‘public utterance mode’) for utterance targeting many persons may be selected, and for the second setting range, an utterance mode (‘personal utterance mode’) for utterance targeting a specific person approaching the robot may be selected.

In a case where the displays 151, that is, front-and rear-surface displays, are provided on the front and rear surface, respectively, of the body, the processor 180 may control front-and rear-surface displays in such a manner that different content items (e.g., different advertisements) are displayed on them. In this case, based on the collected situational information, the processor 180 may control the sound output unit 152 in such a manner as to output sound associated with the display on which content with a significant advertisement effect, or safety-related information is displayed, or which has a high control priority.

The output unit 150 serves to generate outputs associated with senses such as sight, hearing, touch. The output unit 150 may include at least one of the following:
the display 151, the sound output module 152, or the light output module 153. The display 151 may be configured to have either an interlayer structure or an integrated structure incorporating a touch sensor and thus be realized as a touchscreen. The touchscreen may function as a user input unit, which provides an input interface between the guidance robot 100 and the user, and further provide an output interface.

The light output unit 153 outputs a signal for alerting the user to the occurrence of an event in the guidance robot 100, using light emitted by a light source. For example, in a case where a movement command is transferred to the traveling-enabling unit 130 of the guidance robot 100, a signal for alerting the user to the movement of the guidance robot 100 is output through the light output unit 153.

The processor 180 may include an AI learning unit 181 (not illustrated) to perform operations associated with artificial intelligence technologies for the guidance robot. The AI learning unit 181 may be configured to receive, classify, store, and output information that is used for data mining, data analysis, intelligent decision making, and machine learning algorithms and technologies. The AI learning unit 181 may include one or more memory units. Each memory unit is configured to store information that is received, sensed, detected, generated, or predefined through the guidance robot, or information that is output in other ways through the guidance robot. Alternatively, each memory is configured to store data that are received, sensed, detected, generated, predefined, or output by another constituent element, an apparatus, and a terminal.

In one embodiment, the AI learning unit 181 may be integrated into the guidance robot or include the memory. In one embodiment, the AI learning unit 181 may be realized through the memory 170. However, the AI learning unit 181 is not limited thereto. The AL learning unit 181 may be realized either in an external memory associated with the guidance robot 100 or through a memory included in a server capable of communicating with the guidance robot 100. In another embodiment, the AI learning unit 181 may be realized through a memory maintained under a cloud computing environment or a remote memory accessible by the guidance robot through a communication technique such as over a network.

The AI learning unit 181 is configured to store data in one or more databases for purposes such as identification, indexation, classification, manipulation, storage, search and output. The data are typically used for supervised or unsupervised learning, data mining, predication analysis, or other machine learning technologies. The information stored in the AI learning unit 181 may be used by the processor 180 or by a plurality of processors included in the guidance robot. The processor 180 and the plurality of processors use at least one of the following: analysis of different data types, machine learning algorithms, and machine learning technologies. Examples of these algorithms and techniques include k-Nearest neighbor system, fuzzy logic (e.g., possibility theory), neural networks, Boltzmann machines, vector quantization, pulsed neural nets, support vector machines, maximum margin classifiers, hill-climbing, inductive logic systems, Baysian networks, Petri nets (e.g., finite state machines, Mealy machines, and Moore finite state machines), classifier trees (e.g., perceptron trees, support vector trees, Markov trees, decision tree forests, and random forests), pandemonium models and systems, clustering, artificially intelligent planning, artificially intelligent forecasting, data fusion, sensor fusion, image fusion, reinforcement learning, augmented reality, pattern recognition, automated planning, and the like.

The processor 180 may determine or predict executable operations of the guidance robot based on information that is determined or generated using data analysis, machine learning algorithms, and machine learning technologies. To this end, the processor 180 may request, search for, receive, or utilize the data stored in the AI learning unit 181. The processor 180 may perform various functions, such as realizing a knowledge-based system, an inference system, a knowledge acquirement system, and the like. Additionally, the processor 180 may perform various functions, such as realizing a system (e.g., a fuzzy logic system) for inference under uncertainty, an adaptive system, a machine learning system, an artificial intelligence network, and the like.

In addition, the processor 180 may include sub-modules, enabling voice and natural language processing, such as an I/O processing module, an environmental condition module, a voice-text (STT) processing module, a natural language processing module, an operation flow processing module, and a service processing module. In the guidance robot, each of the sub-modules may have the authority to access one or more systems, data and models, or their subsets or supersets. At this point, objects that each of the sub-modules has the authority to access may include scheduling, a vocabulary index, user data, a task flow model, a service model, and an automatic speech recognition (ASR) system.

In one or several embodiments, on the basis of the data stored in the AI learning unit 181, the processor 180 may also be configured to sense and detect a user request by analyzing a contextual condition or the user's intention, which is expressed through user's input or natural language input. When an operation of the guidance robot is determined based on data analysis conducted by the AI learning unit 181, machine learning algorithms, and machine learning technologies, the processor 180 may control the constituent elements of the guidance robot to perform the determined operation. The processor 180 may perform the determined operation by controlling the guidance robot based on a control command.

The memory 170 stores data that support various functions of the guidance robot 100. The memory 170 may store a multiplicity of application programs (or applications) executed on the guidance robot 100, and data and commands for operating the guidance robot 100. In addition, the memory 170 may store a variable call word used for enabling a function of conducting a voice conversation with the user.

The memory 170 may store situational information and data that are collected by the guidance robot 100 through the sensing unit 140, the input unit 120, the communication unit 110, and the like. In addition, the situational information and the data, which are stored in the memory, may be provided to the processor 180.

Example of the memory 170 may include at least one of the following types of storage media: flash memory, hard disk, a solid state disk (SSD), silicon disk drive (SDD), a micro multimedia card, a card-type memory (e.g., SD or DX memory), Random Access Memory (RAM), Static Random Access Memory (SRAM), Read-Only Memory (ROM), Electrically Erasable Programmable Read-Only Memory (EEPROM), Programmable Read-Only memory (PROM), magnetic memory, magnetic disk, or optical disk.

The processor 180 typically controls the overall operation of the guidance robot 100 in addition to operations associated with the application program. The processor 180 may process signals, data, information, and the like that are input or output through the constituent elements described above, execute application programs stored in the memory 170, or control the traveling-enabling unit 130. By doing so, the processor 180 may provide information appropriate for the user or perform functions appropriate for the user.

Under the control of the processor 180, the power supply unit 190 is internally or externally supplied with electric power and distributes the electric power to the constituent elements included in the guidance robot 100. The power supply unit 190 may include a battery. The battery may be an internal battery or a replaceable battery.

At least one or several of the constituent elements may cooperate to operate or control the guidance robot, as described below in various embodiments, or to implement a method of controlling the guidance robot. In addition, the operating or controlling of the guidance robot, or the method of controlling the guidance robot may be performed in the guidance robot by executing at least one application program stored in the memory 170.

Various embodiments disclosed below may, for example, be implemented on a recording medium readable by a computer or a similar apparatus, using software, hardware, or any combination thereof.

According to embodiments of the present disclosure, the guidance robot capable of traveling autonomously and delivering utterances with volume adjustment, and a method of operating the guidance robot are described in detail below.

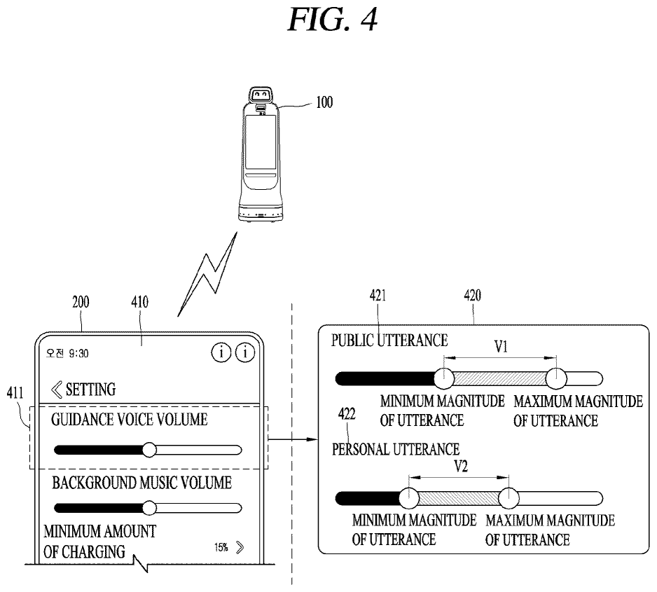

In this regard, FIG. 3 is a flowchart illustrating a method 300 of applying a range for utterance volume settings in a manner that varies depending on whether or not to satisfy a condition corresponding to the situational information. FIG. 4 is a view illustrating an exemplary setting screen associated with FIG. 3.

Unlike a device designed for personal use, the guidance robot 100 may not only provide services to a multiplicity of persons, but may also provide customized services to specific persons. In this manner, the guidance robot 100 may be used for various purposes, and thus there is a need to adjust the volume of an utterance depending on the purpose when the utterance is delivered to provide a service. For example, in a case where the sound used for advertisements targeting a multiplicity of persons is the same as the sound used for advertisements targeting an individual, this may cause the inconvenience in use, such as the individual being surprised to hear the sound.

Accordingly, based on the situational information collected through the sensing unit 140, the processor 180 of the guidance robot 100 according to the present disclosure adjusts the volume of an utterance associated with preset guidance information or visual information displayed on the display 151, and outputs the utterance to the sound output unit 152 at the adjusted volume.

According to one embodiment, based on the collected situational information, in a case where a first condition is satisfied, the processor 180 of the guidance robot 100 may perform control to adjust the volume of an utterance within a first setting range. In a case where a second condition is satisfied, the processor 180 may perform control to adjust the volume of the utterance within a second setting range different from the first setting range.

At this point, the first setting range may have a greater volume adjustment magnitude than the second setting range. Alternatively, in a state where the first setting range and the second setting range partially overlap, the maximum value within the second setting range may be set to be lower than the maximum value within the first setting range. Alternatively, in the state where the first setting range and the second setting range partially overlap, the minimum value within the second setting range may be set to be lower than the minimum value within the first setting range.

According to one embodiment, the first condition applies to utterances targeting an unspecified multiplicity of persons, and the second condition applies to utterances targeting a specific person.

At this point, the specific person may refer to an individual who satisfies a specific condition rather than an explicitly specified person. For example, the specific person may refer to a visitor who approaches within a predetermined distance of the robot in a predetermined space. Therefore, the specific person does not necessarily refer to a single person and may refer to a small number of visitors within a predetermined range of distance from the robot.

With reference to FIG. 3, the processor 180 of the guidance robot 100 may determine whether or not an utterance function of the robot targets a multiplicity of persons (310). This determination may be made in real time based on the situational information updated before or during the robot's utterance.

In a case where the utterance function of the robot targets a multiplicity of persons, the volume of an utterance may be adjusted within the first setting range (320). For example, in a case where an utterance targets a multiplicity of persons, such as in a signage advertisement or a docent service, the utterance may begin at a specific value (e.g., the median or maximum value) with the first setting range.

In a case where the utterance function of the robot does not target a multiplicity of persons, the volume of an utterance may be adjusted within the second setting range different from the first setting range (320). For example, in a case where a response utterance targets an individual such as when a customer uses the robot (e.g., an in kiosk mode, for a path guidance inquiry, or for a similar purpose), the response utterance may be delivered at a specific value (e.g., the median or minimum value) within the second setting value range, which has lower minimum and maximum values than the first setting range.

Next, the guidance robot 100 adjusts the volume of an utterance depending on an utterance target or purpose in this manner and then delivers an utterance at the adjusted magnitude of the volume (340). For example, an utterance targeting a multiplicity of persons may be delivered at a higher volume, and an utterance targeting an individual may be delivered at a lower volume.

This adjustment of the volume of an utterance may be made adaptively and repeatedly depending on varying situational information.

According to one embodiment, an utterance function targeting a multiplicity of persons and an utterance function targeting an individual may be performed alternately. For example, while in response to a specific person's path guidance inquiry, the guidance robot 100 moves to guide the specific person to the path after delivering the utterance “Please follow me,” the guidance robot 100 guides a multiplicity of persons in the vicinity to the signage advertisement or delivers the utterance “Please step aside” as a traveling warning alert. In this case, according to the utterance purpose, an utterance mode corresponding to the first setting range and an utterance mode corresponding to the second setting range may be executed alternately.

In FIG. 4, an example of a setting screen for effectively adjusting the volume of an utterance as described with reference to FIG. 3 is illustrated. In FIG. 4, a setting screen 410 of a terminal 200 capable of controlling the guidance robot 100 is illustrated.

With reference to the left side of FIG. 4, in the related art, only a guidance voice volume and a background music volume that can be adjusted through input are present. In the related art, in order for the user or a manager to adjust the volume of an utterance, a guidance voice volume can be adjusted through a first graphic object 411 or can be adjusted for a decrease or increase by touching and dragging leftward and rightward a graphic object corresponding to the background music volume.

From the right side of FIG. 4, it can be seen that, on a setting screen 420 according to the present disclosure, the adjustable guidance voice volume is subdivided according to the utterance purpose. Specifically, the guidance voice volume may include the volume of a public utterance 421 whose volume is adjusted within a first setting range V1, and the volume of an individual utterance 422 whose volume is adjusted within a second setting range V2.

According to one embodiment, to serve more various purposes, the guidance voice volume may also be subdivided into three or more types of volume (e.g., the volume of a public utterance, the volume of an individual utterance, and the volume of a small-group utterance), or may also be additionally adjusted by applying a weighting value within the first and second setting ranges. For example, weighting values may also be preset in a manner that varies according to an utterance place (e.g., a quiet place or a similar place) and an utterance time span (e.g., daytime or nighttime). Accordingly, the volume of an utterance may also be adjusted to a low or high value within the first and second setting ranges.

According to one embodiment, the guidance robot 100 may adjust the volume of an utterance depending on types of situational information.

For example, path guidance information may be recognized through the individual utterance, and an utterance mode for the path guidance information is changed to be at a volume of an utterance within the second setting range, thereby decreasing the maximum utterance magnitude. For example, information associated with the robot's traveling may be recognized through the public utterance, and an utterance mode for the information is changed to be at a volume of an utterance within the first setting range, thereby increasing the maximum utterance magnitude. The reason for this is that, for the safety purpose, a multiplicity of visitors in the vicinity are required to be guided to recognize the information associated with the robot's traveling. In addition, for example, while the public utterance is delivered, when a visitor in the vicinity stands before the robot and the expression of visitor's intention to use the robot (e.g., screen touch) is ascertained, the public utterance may be changed to the individual utterance.

In this manner, the guidance robot 100 makes an adaptive adjustment by itself depending on the public utterance, the individual utterance, or both. Thus, a visitor can more accurately recognize the content uttered by the robot, thereby eliminating the inconvenience in use caused by the sound volume magnitude.

Examples where the volume of an utterance is adjusted based on the situational information collected during a traveling mode of the guidance robot 100 are described below.

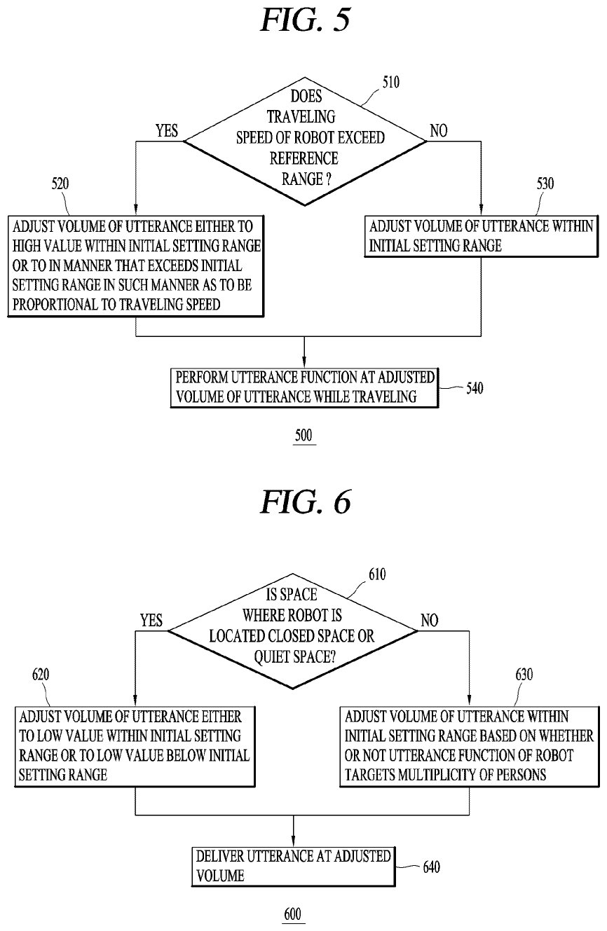

Specifically, FIG. 5 is a flowchart illustrating the adjustment of the volume of an utterance depending on a traveling speed during the guidance robot's traveling. FIG. 6 is a flowchart illustrating the adjustment of the volume of an utterance depending on the traveling space during the guidance robot's traveling.

First, with reference to FIG. 5, during the guidance robot 100's traveling, for the safety purpose, the traveling warning alert is required to be output in a sound format, thereby encouraging visitors in the vicinity to readily avoid the guidance robot 100. Particularly, during the robot's traveling, the same hearing time are required to be provided to visitors in the vicinity.

Accordingly, while the robot travels, the guidance robot 100 detects the traveling speed of the robot through a sensor (e.g., a speed detection sensor or the like) of the sensing unit 140, and the processor 180 determines whether or not the traveling speed of the robot exceeds a reference range (510). At this point, the reference range refers to a threshold speed range where an adjustment for providing the same hearing time to visitors in the vicinity is necessary, or the minimum speed value. That is, at the traveling speed that does not reach the reference range, it is not necessary to provide the same hearing time to visitors in the vicinity.

When the traveling speed of the robot does not reach the reference range, the volume of an utterance is adjusted within an initial setting range (530). At this point, the initial setting range serves as a setting range for an utterance mode preselected according to an utterance target or purpose of the guidance robot 100. In a case where the utterance targets a multiplicity of persons, the initial setting range refers to the first setting range. In a case where the utterance targets a specific person, the initial setting range refers to the second setting range, which is narrower than the first setting range.

According to one embodiment, the processor 180 of the guidance robot 100 may recognize the traveling speed detected through the sensor, as the collected situational information, and, based on the detected traveling speed, may adjust the volume of an utterance within the first setting range. At this point, the volume of an utterance is adjusted in direction and degree to provide the same hearing time to visitors in the vicinity.

Specifically, the traveling speed of the robot exceeds the reference range, the volume of an utterance may be adjusted in proportion to the traveling speed, either to a high value within the initial setting range or to a high value beyond the initial setting range (530). At this point, the volume of an utterance may be at a high value within the initial setting range, for example, at the maximum value within the first setting range. In addition, the volume of an utterance may be at a high value exceeding the initial setting range, for example, at a value that is higher than the maximum value within the first setting range.

While the robot utters during traveling, the volume of an utterance may be increased in proportion to the traveling speed in this manner. Thus, the same hearing time may be provided to visitors in the vicinity, thereby enabling them to accurately recognize the utterance.

When the traveling speed of the robot is decreased, the volume of an utterance is decreased back in proportion to the decreased traveling speed. For example, while the guidance robot 100 travels at a great speed, an utterance may be delivered at the volume with the maximum value within the first setting range. When the traveling speed decreases below the reference range, an utterance may be delivered in an automatically adjusted manner at a volume with the minimum value within the second setting range.

In addition, according to one embodiment, like a traveling warning alert, a warning sound associated with safety may also be uttered at a fixed pitch and volume (e.g., high tone and large volume) regardless of the traveling speed of the robot.

In addition, according to one embodiment, only when an utterance associated with preset guidance information is delivered, the processor 180 of the guidance robot 100 may adjust the magnitude of the volume of an utterance either within the first setting range or in a manner that exceeds the first setting range, in such a manner as to be proportional to the magnitude of the traveling speed detected through the sensing unit 140. That is, in a case where an utterance associated with information other than the preset guidance information is delivered, persons are not required to readily avoid the guidance robot 100. Therefore, the processor 180 may determine that a condition for adjusting the volume of an utterance is not satisfied.

Next, with reference to FIG. 6, the adjustment of the volume of an utterance depending on the traveling space of the robot is described in detail.

Even when the guidance robot 100 travels autonomously in a predetermined space, reverberation occurs when an utterance is delivered in a closed place, such as an elevator, or in a narrow place, such as a corridor. Therefore, there is a need to turn down the volume. In addition, in a space that is not a narrow space but where everyone is required to be quiet, such as a lecture room, a library, or a hospital, even when the robot needs to deliver an utterance, the robot needs to turn down the volume.

Accordingly, the processor 180 of the guidance robot 100 may adjust the volume of the utterance within the first setting range, depending on whether or not the traveling space for the robot is a closed space or a quiet space. This adjustment is made by the guidance robot's recognition of the traveling space through at least one sensor (e.g., a camera sensor, an IR sensor, or the like) of the sensing unit 140.

At this point, the closed space may be a narrow space, such as an elevator, a long corridor, or a room, where reverberation occurs when the robot delivers an utterance. In addition, the quiet space includes a place where conversations are characteristically prohibited or limited to simple ones or the vicinity of this place. In addition, the classification of the closed spaces and the quiet spaces and their examples may be pre-stored in the memory 170 of the guidance robot or a similar storage device.

In addition, the first setting range refers to an adjustable volume range that corresponds to an utterance mode for the public utterance.

According to one embodiment, if the traveling space recognized through the sensor is determined to be a closed space or a quiet space, the processor 180 may adjust the magnitude of the volume of an utterance either to the minimum value within the first setting range or to a value lower than the minimum value.

Specifically, in a method 600 in FIG. 6, the guidance robot 100 ascertains its current location and, through the camera sensor, the IR sensor, or the like (or by ascertaining the current location on a pre-stored spatial map), determines whether or not the traveling space for the robot is a closed space or a quiet space (610).

In a case where the result of the determination (610) indicates that the robot is located in the traveling space that is classified as a closed space or a quiet space, the volume of the robot's utterance is adjusted either to a low value within the initial setting range (e.g., the first setting range V1 in FIG. 4) or to a low value below the minimum value within the initial setting range (620). In addition, when necessary, for example, when an utterance is not for the traveling warning alert, the utterance is replaceable with a subtitle on the display.

Conversely, in a case where the result of the determination (610) indicates that the robot is located in the traveling space other than a closed space or a quiet space, the volume of an utterance is adjusted within the initial setting range based on whether or not the utterance function of the robot targets a plurality of persons (630). In other words, at this point, the volume of an utterance may be adjusted according to the process described with reference to FIG. 3.

When the volume of an utterance is adjusted in this manner, the utterance is delivered at the adjusted volume (640). For example, the guidance utterance “What floor would you like to go to?” may be decreased to the magnitude of the minimum value within the first setting range and then be output. Alternatively, when moving along with a visitor in an open space, the robot may deliver an utterance at the median value within the first setting range V1 (FIG. 4) or the maximum value within the second setting range V2 (FIG. 4). Then, when moving along with the visitor in a narrow space, the robot may decrease the path guidance utterance “We are going to make a left turn ahead” to the magnitude of the minimum value within the first setting range and then output the path guidance utterance.

In a case where the characteristics of the traveling space change while the guidance robot delivers an utterance during movement, the processor 180 of the guidance robot 100 may perform a process of adjusting the volume of an utterance by selecting a lower magnitude. For example, in a case where the traveling space changes to a closed space or a quiet space in a state where a guidance sentence utterance is not finished, the magnitude of the volume of an utterance may be decreased in accordance with the changed characteristic. Accordingly, the utterance “(at the normal magnitude of the volume) Now we make a left turn” and the utterance “(at the low magnitude when arriving at a closed space or a quiet space) We move forward and find the destination” are delivered.

An improvement in usability can be expected by understanding the characteristics of the traveling space and adjusting the magnitude of an utterance in this manner.

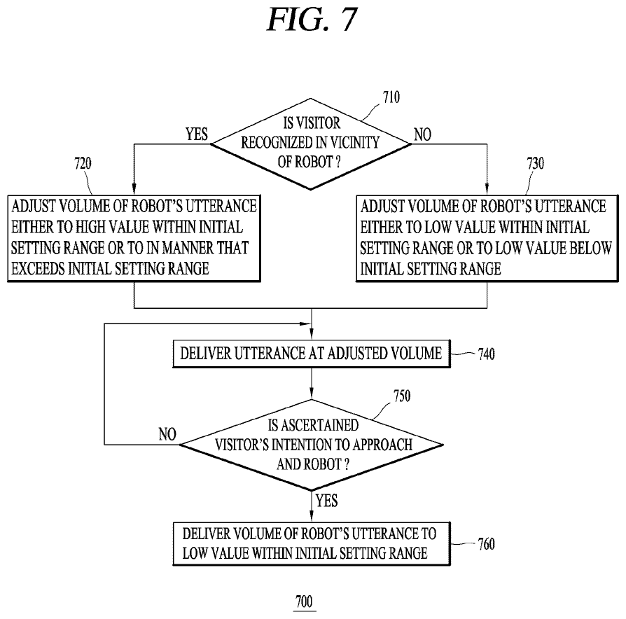

FIG. 7 is a flowchart illustrating a method 700 for the guidance robot to adjust the volume of an utterance depending on the number of visitors and whether or not a visitor approaches. Each step of the method 700 may be continuously repeated while the signage function or utterance function of the robot is in an activated state.

In a case where the guidance robot 100 performs a signage advertisement function, advertisement display and sound are repeated without any change regardless of whether or not a person is present in the vicinity. Due to this repetition, individuals or guides, who are residents in stores in the vicinity, perceive the sound as noise and feel uncomfortable. Accordingly, the guidance robot 100 according to the present disclosure is realized in such a manner that signage advertisement sound is adaptively adjusted in a manner that distinguishes between a case where a visitor is present and a case where no visitor is present.

In the method 700 illustrated in FIG. 7, the guidance robot 100 recognizes whether or not a visitor is present in the vicinity of the current location of the robot, through at least one sensor (e.g., a camera sensor or the like) of the sensing unit 140 (710). While the guidance robot moves, it may also be sensed whether or not a visitor is present in the vicinity. At this point, while the robot moves, it may be sensed at shorter time intervals whether or not a visitor is present.

The processor 180 of the guidance robot may adjust the volume of an utterance within the first setting range based on whether or not a visitor is present in the vicinity of the robot.

Specifically, when the result of the determination (710) indicates that a visitor is recognized as being present in the vicinity of the robot, the processor 180 adjusts the volume of the robot's utterance either to a high value within the initial range, for example, in the first setting range, or to a high value beyond the initial setting range (720). That is, an utterance associated with content displayed on the display 151 is delivered at a high sound volume. Thus, an advertisement effect can be increased.

Specifically, when the result of the determination (710) indicates that no visitor is recognized as being present in the vicinity of the robot, the processor 180 adjusts the volume of the robot's utterance either to a low value (to the minimum value) within the initial range, for example, in the first setting range, or to a low value below the initial setting range (730). That is, when a visitor is absent in the vicinity, an utterance is delivered at a low sound volume. Thus, the inconvenience of experiencing noise can be eliminated, and electric power can also be less consumed.

While an utterance is delivered at the adjusted volume in this manner (740), the guidance robot 100 may ascertain the visitor's intention to approach and use the robot (750).

At this point, different sensors may detect whether or not a visitor approaches the robot and whether or not a visitor uses the robot, respectively. For example, it may be detected through the proximity sensor 141 of the sensing unit 140 and/or the camera that a visitor approaches the robot. The intention of the approaching visitor to use the robot may be detected through a (proximity) touch sensor of the display 151 and/or the recognition of the facial direction.

When the intention of the visitor to approach and use the robot is ascertained, the guidance robot 100 may (stop traveling and then) adjust the volume of an utterance either to a value (the minimum value) lower than before within the initial setting range, for example, within the first setting range or to a low value within the second setting range (760).

In addition, the processor 180 of the guidance robot may deliver an utterance by switching from the public utterance to the individual utterance. Therefore, a visitor, approaching the robot to use it, does not experience the inconvenience of being startled at an utterance with an excessively high sound volume.

In a case where a visitor who approaches the robot moves away from the robot (either without actually using the robot or after using the robot), an utterance may be delivered by switching the utterance mode to the public utterance. Accordingly, the volume of an utterance may be adjusted within the first setting range based on whether or not a visitor in the vicinity of the robot is recognized.

For example, in response to an approaching visitor moving away from the robot, the processor 180 of the guidance robot may adjust the volume of an utterance to a value higher than before within the first setting range. Alternatively, when a predetermined time elapses after it is detected that an approaching visitor moves away from the robot, the processor 180 of the guidance robot may enable an utterance to be delivered by switching the utterance mode from the personal utterance to the public utterance.

According to one embodiment, the volume and direction of an utterance may also be adjusted depending on how many visitors are present in the vicinity of the guidance robot 100, that is, depending on the degree of visitor congestion. Specifically, when the degree of visitor congestion is high, the volume may be adjusted to a high value to enhance the advertisement effect, the direction of an utterance may be adjusted upward to avoid startling a visitor who moves in the vicinity of the robot, or an utterance may be output using a surround/rear speaker that provides a stereoscopic sound experience.

Specific examples associated with the utterance function of the guidance robot 100, which includes displays on the front and rear surfaces, respectively, of the body, that is, a plurality of displays, are described below.

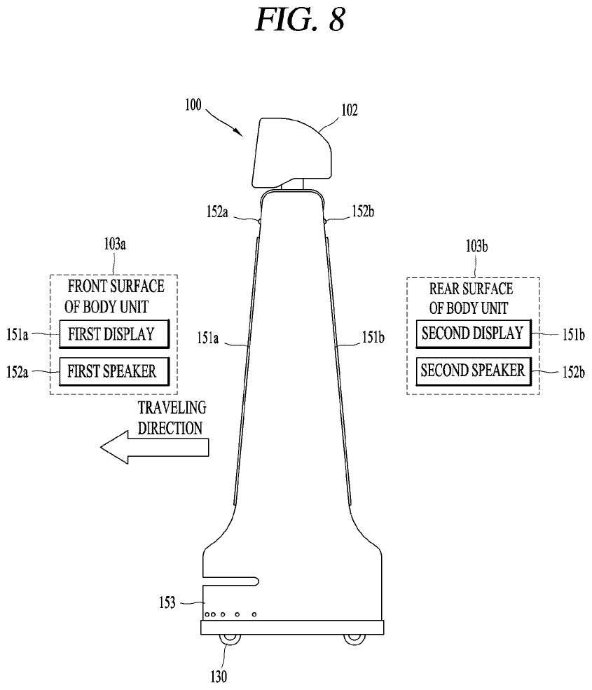

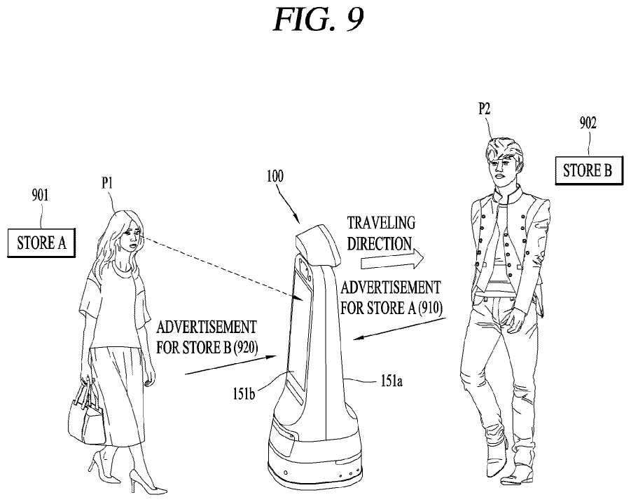

FIG. 8 is a view illustrating that while the guidance robot including a plurality of displays travels, different content items are displayed on the plurality of displays, respectively, that are included in the guidance robot. FIG. 9 is a set of views associated with the selective output of an utterance in FIG. 8 based on the situational information.

The guidance robot 100 according to still another embodiment of the present disclosure may include a first display 151a and a first speaker 152a on the front surface 103a of the body unit positioned between the head unit 102 and the traveling-enabling unit 130, and a second display 151b and a second speaker 152b on the rear surface 103b of the body unit.

The guidance robot 100 may display different screen information pieces to the first display 151a and the second display 151b, respectively, while traveling. For example, when the signage advertisement function is enabled to perform, the processor 180 of the guidance robot 100 may display different advertisement content items on the first display 151a and the second display 151b, respectively.

Sound associated with screen information displayed on the first display 151a may be output through the first speaker 152a. In addition, sound associated with screen information displayed on the second display 151b may be output through the second speaker 152b.

In a case where different advertisement content items are displayed on the first display 151a and the second display 151b, respectively, sound may be selectively output through only one of the first and second speakers 152a and 152b in such a manner as to prevent sound overlap.

Based on the situational information collected through the sensing unit 140, the processor 180 of the guidance robot 100 may control the output unit, for example, one of the first and second speakers 152a and 152b, in such a manner as to output that an utterance associated with content displayed on one of the first and 2-second displays 151a and 151b.

With reference to FIG. 9, while traveling, the guidance robot 100 displays first advertisement content 910, for example, ‘Advertisement for Store A’ on the first display 151a and may display second advertisement content 920, for example, ‘Advertisement for Store B’ on the second display 151b.

At this point, the first advertisement content 910 displayed on the first display 151a is visible to a visitor P2 who moves in the opposite direction to the traveling direction of the guidance robot 100. Therefore, the first advertisement content 910 may be selected as an advertisement associated with a POI (e.g., a place that the robot passes) located in the opposite direction of the traveling direction of the guidance robot 100, for example, with Store A 901.

In contrast, the second advertisement content 920 displayed on the second display 151b is visible to a visitor P1 who moves in the same direction as the traveling direction of the guidance robot 100. Therefore, the second advertisement content 920 may be selected as an advertisement associated with a POI (e.g., a place that the robot moves toward) located in the traveling direction of the guidance robot 100, for example, with Store B 902.

The visitors P1 and P2 are assumed to move in the current directions illustrated, respectively. That is, the visitor P1 is assumed to move in the same direction as the traveling direction of the robot, and the visitor P2 is assumed to move in the opposite direction to the traveling direction of the robot. Based on this assumption, the first display 151a visible to the visitor P2 is exposed only for a short time. In contrast, the second display 151b is continuously exposed while the visitor P2 moves in the same direction as the traveling direction of the robot.

Accordingly, according to the present disclosure, the processor 180 of the guidance robot 100 may output sound associated with one, having a longer exposure time, of the displays exposed to a visitor. For example, sound associated with advertisement content displayed on the display on the rear surface, which has a longer time to the visitor P1 in FIG. 9, that is, on the second display 151b, may be output through the second speaker 152b. Instead of the associated sound, a subtitle or the like may be substituted to be displayed on the display on the side where the associated sound is not output, for example, on the first display 151a. To this end, a function of displaying a subtitle on the first display 151a may be adaptively turned on or off.

In this manner, the associated sound may be output by assigning a high priority to a content advertisement that has a long exposure time and a long duration of sound availability. Thus, the advertisement effect can be further maximized.

When the guidance robot 100 changes its traveling direction, advertisement content items may be differently displayed on the first and second displays 151a and 151b, respectively. Accordingly, the associated advertisement sound may also be changed.

In addition, according to one embodiment, while the guidance robot 100 does not travel, the associated sound is not output based on the second display 151b on the rear surface in the opposite direction to the traveling direction of the robot. Instead, sound associated with one, in the direction in which a visitor approaches or a greater number of visitors are present, of the first and second displays 151a and 151b, may be output. Accordingly, a signage advertisement effect can be further increased.

Even in a case where sound associated with advertisement content is selectively output, an important utterance associated with safety may be delivered using both speakers on the front and rear surfaces, that is, the first and second speakers 152a and 152b. That is, a guidance utterance and an utterance for the robot's movement or event are set to have higher priority than sound associated with the signage advertisement.

The reason for this is that the guidance robot 100 characteristically performs the signage advertisement function while moving. For example, various warning sounds associated with safety, such as the traveling warning alert, may be uttered.

The various warning sounds may include, for example, a traveling sound, an abrupt movement alert utterance in a specific situation (for example, a backward movement alert utterance), an utterance associated with the robot's abnormal movement, and the help-asking utterance “Please step aside,” among others.

In addition, the warning sound associated with safety is required to be uttered at a volume with a predetermined level or higher in such a manner as to be recognized by a visitor. Thus, the minimum value within the adjustable volume of an utterance may be preset. Therefore, even when the current volume of the robot's utterance is set to a low value, the warning sound associated with safety may be uttered at least at the minimum value within the preset volume of an utterance.

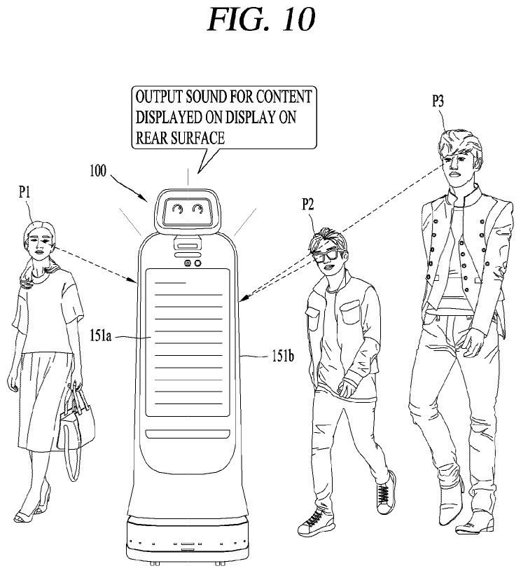

FIGS. 10, 11, 12A, and 12B are views illustrating various examples, respectively, where in the guidance robot including the plurality of displays, an utterance associated with content on a display selected based on the direction in which a visitor approaches is output.

The guidance robot including the plurality of displays, for example, the first and second displays 151a and 152b, may display different advertisement content items, respectively, on them while traveling. At this point, different advertisement content items displayed on the plurality of displays, for example, the first and second displays 151a and 152b, respectively, may be determined to be associated with the current location of the robot and the direction that each display faces.

At this point, the sound or utterance associated with any one advertisement content item may be selectively output in such a manner that sounds associated with different advertisement content items do not overlap.

According to one embodiment, while the guidance robot travels, the processor 180 of the guidance robot 100 may control the output unit, for example, the second speaker 152b in such a manner as to output an utterance associated with content displayed on the display on the rear surface, that is, on the second display.

With reference to FIG. 10, visitors P1, P2, and P3 that move behind the guidance robot 100 in the same direction as the guidance robot can view advertisement content displayed on the display on the rear surface, that is, on the second display 151b, and sound associated with the advertisement content displayed on the second display 151b is output. At this point, another advertisement content item may be output on the display on the front surface of the guidance robot 100, that is, on the first display 151a, and a subtitle is substituted for the sound to be output.

The reason for this is that, in a case where the guidance robot 100 travels, higher priority is assigned to sound associated with advertisement content displayed on the 2-second display 151b because the 2-second display 151b has a longer duration of sound availability.

However, the sound associated with safety when the guidance robot 100 travels, for example, the utterance ‘Please step aside’ may also be output through the first speaker 152a positioned in the same direction as the traveling direction of the robot.

According to one embodiment, the sensing unit 140 of the guidance robot 100 may detect the direction in which a visitor approaches. The processor 180 of the guidance robot 100 may output content (e.g., advertisement content) on the display corresponding to one, corresponding to the detected approaching direction, of the first and second displays 151a and 151b and perform control in such a manner that an utterance associated with the displayed content is output.

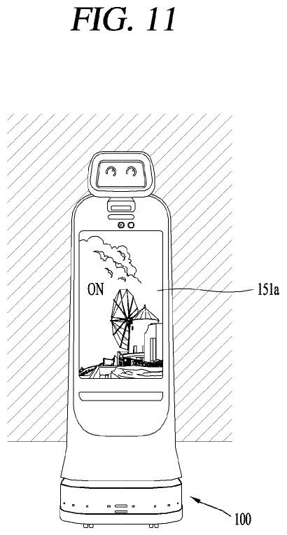

For example, with reference to FIG. 11, in a case where the guidance robot 100 is aligned in such a manner that its rear surface faces a wall for reasons such as charging, advertisement content may be output in a state where the second display 151b on the rear surface remains deactivated and only the first display 151a on the front surface remains activated (turned on). The reason for this is that there is no need to display a signage advertisement in a state where a visitor cannot approach the second display 151b.

In addition, the guidance robot 100 may detect the direction in which a larger number of visitors are present and, while traveling in the detected direction, may output different advertisement content items to the first and second displays 151a and 151b, respectively.

In addition, when delivering an utterance, the guidance robot 100 may deliver the utterance through the speaker positioned in the direction corresponding to the direction in which a visitor approaches, for example, through one, positioned in the direction in which a visitor approaches, of the first and second speakers 152a and 152b.

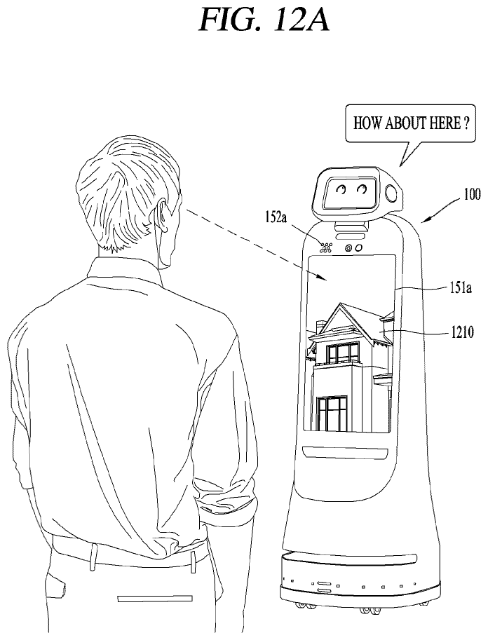

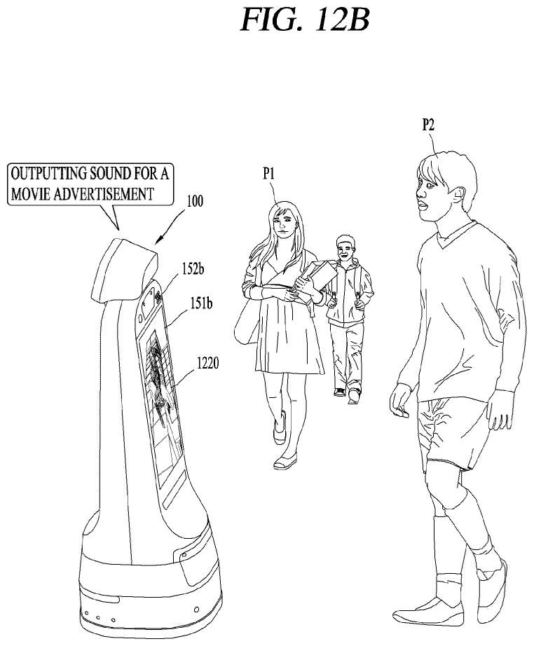

For example, as illustrated in FIG. 12A, in a case where a visitor approaches the front surface of the guidance robot 100, the content of an utterance associated with advertisement content 1210 displayed on the first display 151a on the front surface, for example, such as “How about here!,” may be output through the first speaker 152a on the front surface in the direction of the utterance.

Alternatively, for example, as illustrated in FIG. 12B, in a case where a visitor approaches the rear surface of the guidance robot 100, the content of an utterance associated with advertisement content 1220 displayed on the second display 151b on the rear surface, for example, such as “Sound for A movie advertisement,” may be output through the second speaker 152b on the rear surface in the direction of the utterance.

FIG. 13 is a view that is referenced to describe a method of selectively outputting an utterance in a case where a visitor approaches all of the plurality of displays included in the guidance robot 100.

The guidance robot 100 may detect, through the sensing unit 140, the direction in which a visitor approaches. The processor 180 may output an utterance associated with content displayed on one, corresponding to the detected approaching direction, of the first and second displays 151a and 151b. At this point, in a case where the detected approaching direction corresponds to both the first and second displays, the processor 180 may control the output unit, that is, the corresponding speaker in such a manner as to preferentially output an utterance associated with content displayed on any one display selected according to a preset reference.

At this point, the preset reference may be associated with priorities for controlling the first and second displays, which are assigned based on the collected situational information.

For example, a higher priority for control may be assigned to one, in the direction in which a visitor first approaches, of the first and second displays 151a and 151b. Alternatively, for example, a higher priority for control may be assigned to one, in the direction in which a visitor's intention to use the robot is first ascertained, of the first and second displays 151a and 151b.

In FIG. 13, in a case where a higher priority for control is assigned to a visitor who approaches the first display 151a on the front surface, only sound (Sound for A advertisement) associated with advertisement content on the first display 151a is output. Conversely, in a case where a higher priority for control is assigned to a visitor who approaches the second display 151b on the rear surface, only sound (Sound for B advertisement) associated with advertisement content on the second display 151b is output.

At this point, instead of sound for the display in the direction of having a low priority for control, a subtitle or a graphic object associated with the subtitle is substituted to be displayed on the corresponding display. The reason for this is that, even when the independent use of the first and second displays 151a and 151b can enhance usability, the bidirectionally delivery of the guidance robot's utterance (e.g., guidance voice) may confuse a user in a case where the first and second displays 151a and 151b are used simultaneously in a bidirectional manner.

In addition, feedback interaction for the display in the direction of having a low priority for control may be performed through a touch sound, a change in the facial expression of the head unit 102 of the guidance robot, an LED light output means, and the like.

Alternatively, the processor 180 may activate the speaker in the direction of the display to which a high priority for control is assigned and may activate a sub-display for a touch sound, a subtitle function, and a facial interaction of the head unit 102 in the direction of the display to which a low priority for control is assigned.

The guidance robot according to the present disclosure can display different advertisement content items on the displays, respectively, on both the surfaces, thereby increasing the advertisement effect. As a result, the direction of increasing the advertisement effect can be selected by considering both the traveling direction of the robot and the direction in which a visitor approaches, and thus, the associated sound is uttered. Consequently, the advertisement effect can be further maximized.

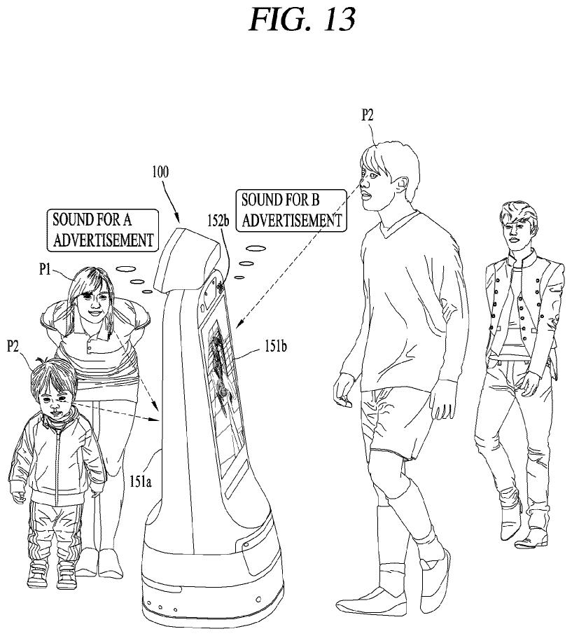

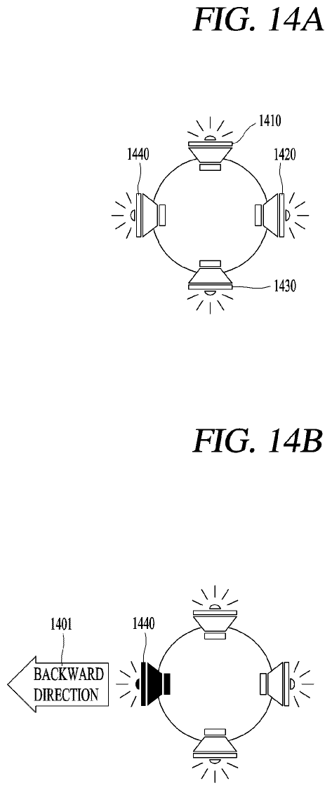

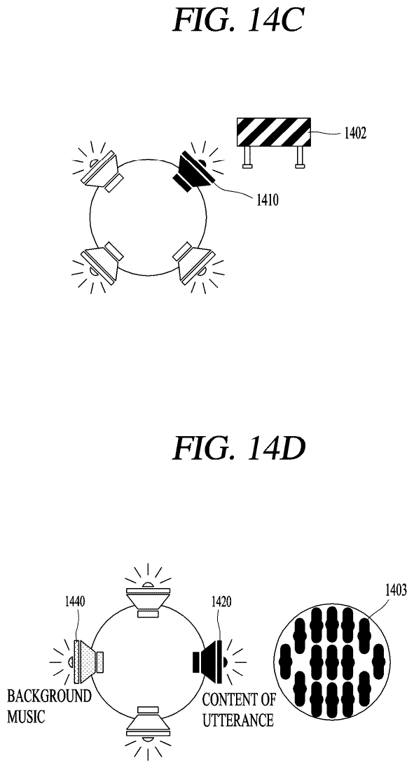

FIGS. 14A to 14D are views illustrating various examples, respectively, where the guidance robot 100 uses an array speaker to vary the direction of outputting an utterance.

FIG. 14A is a conceptual view illustrating the array speaker, which is referenced to describe the direction of outputting an utterance. As illustrated in FIG. 14A, the array speaker may output sound in one or more directions determined from many directions, for example, the first to fourth directions 1410, 1420, 1430, and 1440.

According to one embodiment, the array speaker may be mounted in the guidance robot 100 in such a manner as to output sound in many directions, and, when the guidance robot 100 outputs an utterance, the processor 180 may control the array speaker in such a manner as to output the utterance in a selected direction, based on the situational information detected through the sensing unit 140.

Specifically, in a case where directional information is included in an utterance associated with traveling, the processor 180 of the guidance robot 100 may control the array speaker in such a manner as to output the utterance only in the direction corresponding to the directional information.

For example, as illustrated in FIG. 14B, when the guidance robot travels in a backward direction 1401, the traveling-associated utterance, for example, ‘Backward traveling in progress. Please step aside’ may be output in an output direction 1440 corresponding to the backward direction 1401. Accordingly, a visitor in the vicinity of the backward direction 1401 can hear the utterance and then readily avoid the guidance robot.

Alternatively, for example, as illustrated in FIG. 14C, based on the detection of an obstacle 1402 approaching in the traveling direction of the guidance robot, the traveling-associated utterance, for example, ‘Please step aside’ may be output in an output direction 1410 corresponding to the detected direction of the obstacle. Accordingly, the approaching obstacle 1402 may readily move to avoid the guidance robot.

In addition, in order to maximize the sense of space, the processor 180 of the guidance robot 100 may control the array speaker in such a manner as to output an utterance in the direction in which a visitor or a listener is present and to output background music in the opposite direction.

For example, as illustrated in FIG. 14D, in a case where a docent function is performed, a decent utterance may be output in an output direction 1420 corresponding to the direction in which docent-guided visitors 1403 are present (or the direction in which a large number of visitors are present), and the associated background music may be output in the output direction 1440 opposite to the docent-style utterance.

In this manner, the direction of an utterance may be adaptively adjusted on a per-situation basis using the array speaker in the guidance robot, thereby outputting the utterance. Consequently, an alert can be provided more directly, and the sense of space can be further enhanced.

As described above, the guidance robot and the method of operating the guidance robot according to one or several embodiments of the present disclosure subdivide a range for adjusting the volume of an utterance by distinguishing between a case where the robot's utterance targets an unspecified multiplicity of persons and a case where the robot's utterance targets a specific person. Consequently, the utterance can be delivered at the magnitude of the volume suitable for each situation. Accordingly, a visitor can more accurately recognize the robot's uttered content, and the inconvenience in use, caused by the magnitude of sound, can be eliminated. In addition, regardless of the traveling speed, the robot can maintain the same hearing time. Consequently, the transfer of an utterance can be further enhanced. Furthermore, an improvement in usability can be expected by understanding the characteristics of the traveling space and adjusting the magnitude of an utterance. In addition, an utterance is adjusted in accordance with changing situations, such as when no visitor is present in the vicinity, when a specific person approaches while the utterance targets an unspecified multiplicity of persons, and when an approaching visitor moves away. Consequently, smarter guidance and advertisement can be provided. In addition, different advertisement content items are displayed on the displays, respectively, on both the surfaces, thereby increasing an advertisement effect. As a result, the display with a higher advertisement effect can be selected by considering both the traveling direction of the robot and the direction in which a visitor approaches, and thus, the associated sound can be uttered. Consequently, the advertisement effect can be further maximized. In addition, the direction of an utterance is adaptively adjusted on a per-situation basis using the array speaker, thereby outputting the utterance. Consequently, an alert can be provided more directly, and the sense of space can be further enhanced.

Further scope of applicability of the present disclosure will become apparent from the following detailed description. However, since it could be clearly understood by those skilled in the art various changes and modifications are made within the spirit and scope of the present disclosure, the detailed description and specific embodiments such as preferred embodiments of the present disclosure should be understood as being given only as examples.

The features, structures, effects, and the like described in the embodiments above are included in at least one embodiment of the disclosure, and are not necessarily limited to only one embodiment. Furthermore, the features, structures, effects, and the like illustrated in each embodiment may be combined or modified and implemented in other embodiments by a person skilled in the art to which the embodiments pertain. Therefore, the contents related to these combinations and modifications should be interpreted as being included within the scope of the disclosure.

Although the above description has been made focusing on embodiments, these are merely examples and do not limit the disclosure, and it will be understood by those skilled in the art to which the disclosure pertains that various modifications and applications not exemplified above are possible without departing from the essential characteristics of the embodiments. For example, each component specifically shown in embodiments may be modified and implemented. Differences relating to these modifications and applications should be construed as being included within the scope of the disclosure as defined in the appended claims.

What is claimed is:

1. A guidance robot comprising:
a sensing unit that collects situational information in the vicinity;
a traveling-enabling unit that moves the guidance robot;
a display on which visual information is displayed;
an output unit that outputs an utterance associated with preset guidance information or visual information displayed on the display; and
a processor that is electrically connected to the sensing unit, the display, and the output unit and adjusts the volume of the utterance to be output to the output unit based on the collected situational information.

2. The guidance robot of claim 1, wherein, based on the collected situational information, the processor performs control to adjust the volume of the utterance within a first setting range when a first condition is satisfied and performs control to adjust the volume of the utterance within a second setting range different from the first setting range when a second condition is satisfied, and
wherein the maximum value within the second setting range is set to be lower than the maximum value within the first setting range.

3. The guidance robot of claim 2, wherein the first condition is for a case where the utterance targets an unspecified multiplicity of persons, and the second condition is for a case where the utterance targets a specific person.

4. The guidance robot of claim 2, wherein the sensing unit includes a sensor detecting the traveling speed of the guidance robot, and
wherein the processor recognizes the traveling speed detected through the sensor, as the collected situational information, and, based on the detected traveling speed, adjusts the volume of the utterance within the first setting range.

5. The guidance robot of claim 4, wherein, when the utterance associated with the preset guidance information is output, the processor adjusts the magnitude of the volume of the utterance either within the first setting range or in a manner that exceeds the first setting range, in such a manner as to be proportional to the magnitude of the detected traveling speed.

6. The guidance robot of claim 2, wherein the sensing unit comprises:
a sensor for detecting a traveling space for the guidance robot, and
wherein the processor adjusts the volume of the utterance within the first setting range, depending on whether or not the traveling space recognized through the sensor is a closed space or a quite space.

7. The guidance robot of claim 6, wherein when the traveling space recognized through the sensor is determined to be a closed space or a quite space, the processor adjusts the magnitude of the volume of the utterance either to the minimum value within the first setting range or to a value lower than the minimum value.

8. The guidance robot of claim 2, wherein the sensing unit comprises:
a sensor for detecting whether or not a visitor is present in the vicinity, and
wherein the processor adjusts the volume of the utterance within the first setting range based on the sensor's detection of whether or not a visitor is present in the vicinity.

9. The guidance robot of claim 8, wherein in response to the sensor detecting that no visitor is present in the vicinity, the processor adjusts the magnitude of the volume of the utterance either to the minimum value within the first setting range or to a value lower than the minimum value.

10. The guidance robot of claim 8, wherein the processor recognizes that one of the visitors in the vicinity approaches, and, based on verification of the approaching visitor's intention to use the guidance robot, changes the volume of the utterance to a value lower than before within first setting range or changes the volume of the utterance within the second setting range, for the purpose of adjustment.

11. The guidance robot of claim 10, wherein, in response to the approaching visitor moving away by a predetermined range or greater, the processor adjusts the volume of the utterance to a value higher than before within the first setting range.

12. The guidance robot of claim 1, wherein the display comprises:
a first display provided on the front surface of the body of the guidance robot; and
a second display provided on the rear surface of the body of the guidance robot, and
wherein, based on the collected situational information, the processor controls the output unit in such a manner as to output an utterance associated with content displayed on one of the first and second displays.

13. The guidance robot of claim 12, wherein, while the guidance robot travels, the processor controls the output unit in such a manner as to output an utterance associated with content displayed on the second display.

14. The guidance robot of claim 12, wherein the sensing unit detects the approaching direction of a visitor, and
wherein the processor controls the output unit in such a manner as to output an utterance associated with content displayed on one, corresponding to the detected approaching direction, of the first and second displays.

15. The guidance robot of claim 14, wherein, in response to the detected approaching direction corresponding to both the first and second displays, the processor controls the output unit in such a manner as to output an utterance associated with content displayed on any one display selected according to a preset reference.

16. The guidance robot of claim 15, wherein the preset reference is associated with priorities for controlling the first and second displays, which are assigned based on the collected situational information.

17. The guidance robot of claim 1, wherein the output unit is an array speaker capable of outputting the utterance in a plurality of different directions, and
wherein, when the guidance robot outputs the utterance, based on the situational information, the processor controls the array speaker in such a manner as to output the utterance in a selected direction.

18. A method of controlling a guidance robot, the method comprising:
a step of displaying content on a display;
a step of collecting situation information in the vicinity;
a step of adjusting the volume of an utterance associated with preset guidance information or the displayed content based on the collected situational information; and
a step of outputting the utterance at the changed volume.

19. The method of claim 18, wherein in the step of adjusting the volume of the utterance, based on the collected situational information, the volume of the utterance within a first setting range is adjusted when a first condition is satisfied, and the volume of the utterance is adjusted within a second setting range different from the first setting range when a second condition is satisfied, and
wherein the maximum value within the second setting range is set to be lower than the maximum value within the first setting range.

20. The method of claim 18, further comprising:
a step of displaying different content items on a first display provided on the front surface of the body of the guidance robot and a second display provided on the rear surface of the body of the guidance robot, respectively; and
a step of outputting an utterance associated with content displayed on one of the first and second displays at the adjusted volume, based on the collected situational information.
